(19) United States
(12) Patent Application Publication
(10) Pub. No.: US 2012/0019018 A1
(43) Pub. Date: Jan. 26, 2012

(54) UTENSIL RETRIEVING APPARATUS

(76) Inventors: CAMMIE MALAGA, St. Charles, IL (US); Steve Malaga, St. Charles, IL (US)

(21) Appl. No.: 13/014,296

(22) Filed: Jan. 26, 2011

Related U.S. Application Data
(60) Provisional application No. 61/367,682, filed on Jul. 26, 2010.

(51) Int. Cl. B25J 1/04

(52) U.S. Cl. 294/190

(57) ABSTRACT

A retrieving apparatus is provided. A shaft of the retrieving apparatus may include at least one handgrip. Below the shaft is a deflector used to deflect debris away from a magnetic lower end of the retrieving apparatus. The magnetic lower end may be a single piece of magnetic material or a hollow pipe filled with one or more magnets. Magnets in the hollow pipe may be coupled to a magnet release handle that can slide along a slot that runs along the shaft. The magnet release handle can be used to move the magnet in the hollow pipe away from the magnetic lower.

### CROSS-REFERENCE TO RELATED APPLICATION

The present application claims the benefit under 35 U.S.C. §119(e) of U.S. Provisional Application No. 61/367,682, entitled “Silverware Retrieving Apparatus”, filed Jul. 26, 2010, which is incorporated herein by reference.

### BACKGROUND OF THE INVENTION

The present invention is generally related to retrieval apparatuses and more specifically, to a utensil retrieving apparatus. Restaurants, schools, hospitals and many other facilities that provide food services tend to lose several pieces of metal eating utensils on a daily basis. This may be due to a high volume of patrons and the speed at which dishes and silverware need to be processed for reuse. When cleaning used dishes, metal eating utensils may often be swept into the trashcan along with discarded food that may have been left on plates. Those in-charge of cleaning and running the facilities often do not have the time or patience to dig through trashcans to retrieve all the accidentally discarded metal eating utensils. Over the course of a year the amount of discarded metal eating utensils may total several hundred or even thousands of dollars. Therefore, there is a need for a tool that can quickly retrieve discarded metal eating utensils from trashcans.

### SUMMARY OF THE INVENTION

In one aspect of the present invention, an apparatus is provided that includes a shaft that has an upper end and a lower end, a deflector affixed to the apparatus intermediate the upper end and the lower end, and a magnetic portion of the shaft disposed on at least the lower end of the shaft.

These and other features, aspects and advantages of the present invention will become better understood with reference to the following drawings, description and claims.

### BRIEF DESCRIPTION OF THE DRAWINGS

FIG. 1 illustrates a perspective view of one embodiment of a retrieving apparatus according to the present invention;

FIG. 2 illustrates a cross-sectional view of the retrieving apparatus taken along the line 2-2 of FIG. 1;

FIG. 3 illustrates a front view of the retrieving apparatus in accordance with one exemplary use of the present invention; and

FIG. 4 illustrates a partial cross-sectional view of another exemplary embodiment of the present invention including a magnet release on the retrieving apparatus.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. Broadly, embodiments of the present invention generally provide an apparatus for retrieving metal objects. More specifically, the retrieving apparatus may be used to retrieve metal eating utensils that may be accidentally discarded as trash.

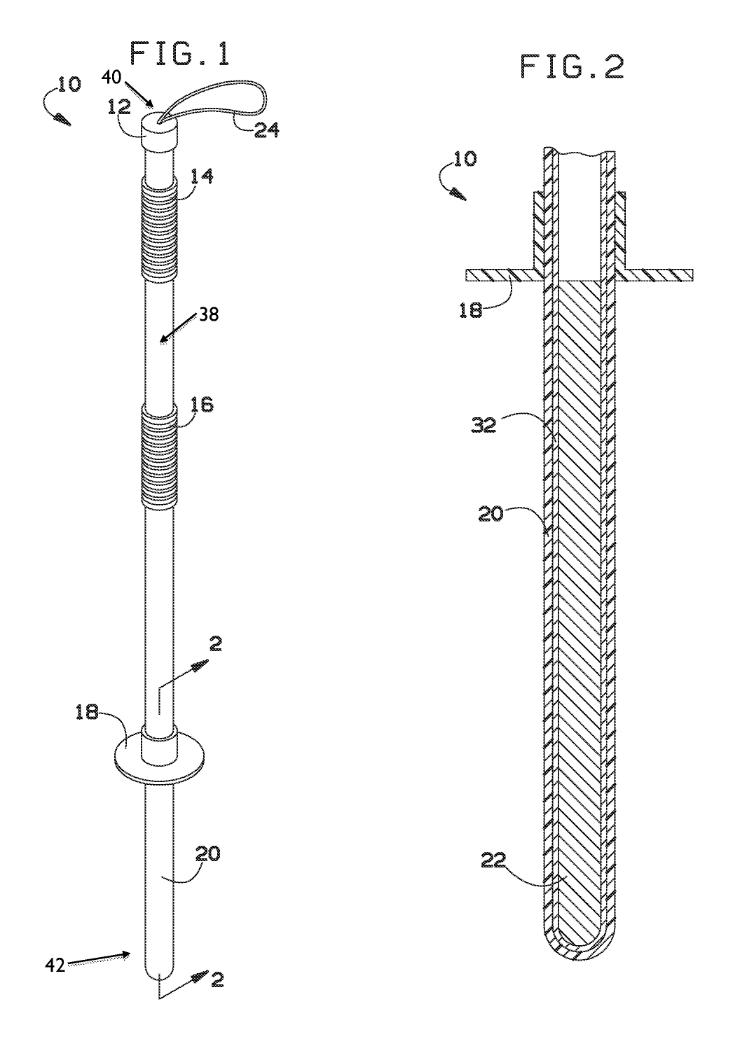

FIG. 1 illustrates an exemplary embodiment of a retrieving apparatus 10 according to the present invention. The retrieving apparatus 10 may include a shaft 38, a magnetic lower end 20, a deflector 18, hand grips 14 and 16, a top cap 12, and a hanging strap 24. The shaft 38 may have an upper end 40 and a lower end 42. The magnetic lower end may be disposed at the lower end 42. Some embodiments of the retrieving apparatus 10 may have a unitary shaft 38 where the magnetic lower end 20 is a part of the shaft 38 while other embodiments may have the shaft 38 and magnetic lower end 20 as two separate pieces that may be coupled together by grooved end fittings, brackets, screws, or other similar fastening means.

The shaft 38 may act as the base of the retrieving apparatus 10 to hold the above described elements in place. The shaft 38 may be made from polyvinyl chloride (PVC), steel, or other similar rigid material. The diameter of the shaft may range from 0.5 to 4 inches. A diameter of 1.5 inches may provide an adequate diameter for holding the above described elements and for comfortably allowing a user to handle the retrieving apparatus 10.

FIG. 1 also illustrates a deflector 18 positioned intermediate of the upper end 40 and the lower end 42 just above the magnetic lower end 20. The deflector may be circular, triangular, rectangular, or any polygonal shape. The deflector 18 may surround the shaft so that the magnetic lower 20 end is hidden when viewing the retrieving apparatus 10 from the upper end 40. The deflector 18 may be affixed to the retrieving apparatus using brackets, screws, bolts, or similar fastening means. One embodiment of the deflector 18 may be made of ether vinyl acetate (EVA) or from molded plastic. The circular deflector 18, for example, may range from 2 to 12 in diameter.

As illustrated in FIG. 1, upper and lower handgrips 14 and 16 may also be affixed to the shaft 38 to assist a user in tightly gripping the retrieving apparatus 10 with two hands. The handgrips 14 and 16 may be made from ridged plastic, rubber, or a molded plastic and have grooves to guide the placement of a user's fingers. The upper handgrip 14 may be located near the top of the retrieving apparatus 10 opposite to the magnetic lower end 20. The lower handgrip 16 may be located 6 to 24 inches below the upper handgrip 14 in order for a user to properly grip and maneuver the retrieving apparatus 10 as necessary. The handgrips 14 and 16 may be permanently affixed to the shaft 38 using glue or they may be inserted over the shaft 38 so they may be maneuvered up and down the shaft 38 as the user requires.

Additionally, a hanging strap 24 may be attached to a top cap 12 on the retrieving apparatus 10. The hanging strap 24 may be made from nylon rope or molded plastic to form a hook. The hanging strap 24 may be used to hang the device for storage when not in use or for securing the retrieving apparatus 10 to a user's wrist which may assist the user in controlling the retrieving apparatus 10 during use.

The magnetic lower end 20 of the retrieving apparatus 10 may be used to attract and collect various metal objects. As illustrated in FIG. 2, the magnetic lower end 20 may be made from a hollow pipe 32 that is filled with one or more magnets 22. Some embodiments of the magnetic lower end 20 may be made from steel that may or may not be magnetized. One embodiment of the magnetic lower end 20 may have a cylindrical shape while other embodiments of the magnetic lower end 20 may have a rectangular shape. A rectangular shaped lower end may provide greater surface area for metal objects to stick to while a cylindrical shaped lower end may allow for easier movement through debris compared to a rectangular shape. As illustrated in FIG. 1-FIG. 4, the distal end of the magnetic lower end may be rounded so the retrieving apparatus may be maneuvered into a pile of debris with greater ease compared to an end that may be flat. The length of the magnetic lower end 20 may be between 6 to 50 inches.

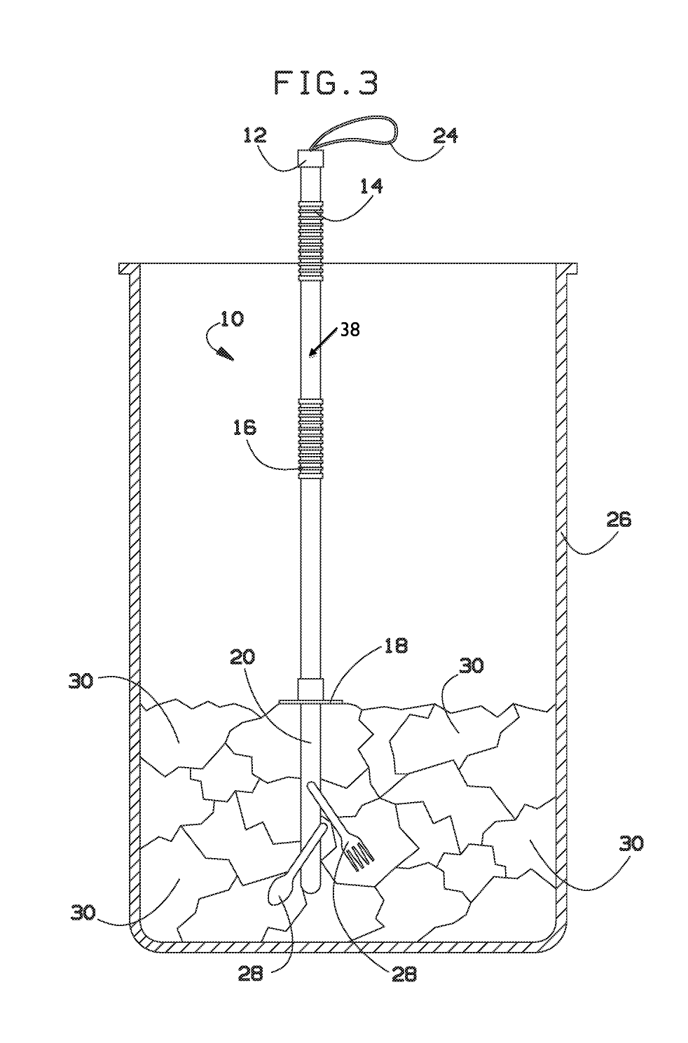

FIG. 3 illustrates operation of the retrieving apparatus 10 to retrieve metal eating utensils from a trash bin. After inserting the retrieving apparatus 10 in the trash bin 26, a user may use the handgrips 14 and 16 along with the hanging strap to control and maneuver the retrieving apparatus 10 in order to allow metal utensils 28 to become attracted to and to stick to the magnetized lower end 20. Since the metal utensils 28 may be hidden in the debris from a user, the user may remove and re-insert the retrieving apparatus 10 in separate parts of the trash bin 26 to ensure that he is thoroughly reaching all parts of the trash bin 26 that may contain utensils 28. As the user removes the retrieving apparatus 10, the deflector 18 may assist in pushing trash and debris 30 away from the collected utensils 28 so debris does not re-engage the objects in order to prevent the collected utensils from falling back into the trash bin 26.

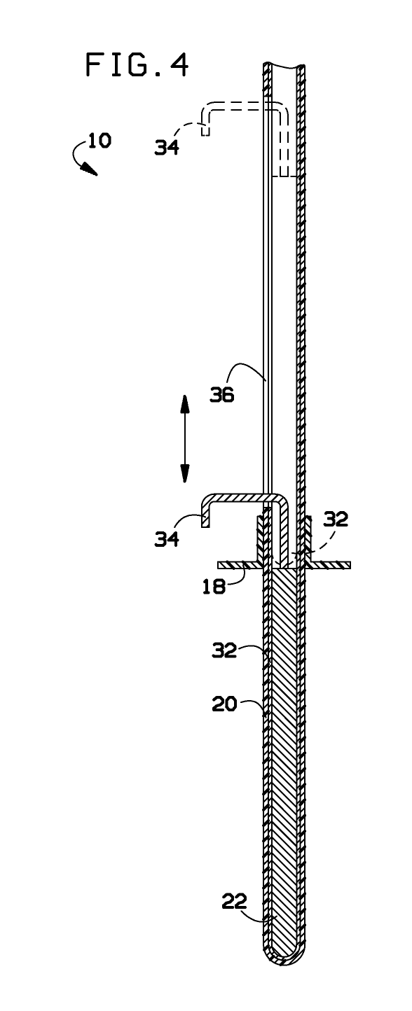

As illustrated in FIG. 4, some embodiments of the retrieving apparatus 10 may also include a magnetic release that may be used to pull the one or more magnets 22 out of the magnetic lower end 20 towards the upper end 40 of the shaft 38. This mechanism may allow the collected metal to easily fall into a desired location. The mechanism may include a magnet release handle 34 that is affixed to the magnet 22 in the hollow pipe 32. The magnet release handle 34 may slide along a magnet release slot 36 that runs up the shaft 38. As the magnet 22 is moved out of the hollow pipe 32, metal objects attracted to the magnet may move up towards the upper end 40. When the metal objects hit the deflector 18 they may fall off into a desired location.

Other embodiments of the device may have the magnetized portion located in different positions and/or arrangements. For example, the elongated shaft may be configured as an “L” shape where the bottom, horizontal portion of the “L” may be the magnetized portion of the device. In yet another embodiment, the shaft may have a handle that may be configured as a “U” shape to allow a user to better handle the device and stir the magnetized portion in a trash bin.

Although the device has been described for use in retrieving silverware from trash bins, other uses may include retrieval of ferrous items, for example, metal or nails in machine shops and/or construction sites.

It should be understood, of course, that the foregoing relates to exemplary embodiments of the invention and that modifications may be made without departing from the spirit and scope of the invention as set forth in the following claims.

What is claimed is:

1. An apparatus comprising:
a shaft including an upper end and a lower end;
a deflector affixed to the apparatus intermediate the upper end and the lower end; and
a magnetic portion of the shaft disposed on at least the lower end of the shaft.

2. The apparatus of claim 1, wherein the magnetic lower end is cylindrical.

3. The apparatus of claim 1, wherein the magnetic lower end is disposed below the deflector.

4. The apparatus of claim 1, wherein the magnetic lower end is a hollow pipe including at least one magnet inside the hollow pipe.

5. The apparatus of claim 4, wherein the hollow pipe is magnetized.

6. The apparatus of claim 4 further comprising:
a slot disposed along a wall of the shaft; and
a magnet release handle coupled to the magnet, wherein the magnet release handle is configured to slide up the slot and pull the magnet out of the hollow pipe towards the upper end.

7. The apparatus of claim 1 further comprising a strap attached to the top of the shaft.

8. The apparatus of claim 1 further comprising a least one hand grip affixed to the shaft.

9. The apparatus of claim 1 wherein the deflector is configured to circumvent the shaft and project radially outward from the shaft.
